(19) United States
(12) Patent Application Publication
(10) Pub. No.: US 2025/0354587 A1
(43) Pub. Date: Nov. 20, 2025

(54) MOLDED SHAFT COUPLER WITH FLAT FLOOR AND BUTTON TRAVEL LIMITER

(71) Applicant: Gregory Lee Newth, Montague, MA (US)

(72) Inventor: Gregory Lee Newth, Montague, MA (US)

(21) Appl. No.: 18/667,119

(22) Filed: May 17, 2024

(51) Int. Cl. F16D 1/112

(52) U.S. Cl. CPC F16D 1/112

(57) ABSTRACT

A single-button coupler comprises a female half coupler and a mating male half coupler that has an injection molded plastic body. The body of the male half coupler has a lengthwise bore. The outer section of the bore is substantially circular, for attachment of a round shaft. The inner section of the bore has a radial opening to the body exterior, within which the button sets. The inner bore section at least has a flat floor, upon which sets the base of the spring that actuates the button. The flat floor preferably runs the whole length of the bore. A button travel limiter adjacent the wall at the end of the inner section of the bore helps locate the spring upon the flat floor during assembly. The button travel limiter stops a user from pushing the button into the inner bore to jam the button.

### FIELD OF INVENTION

The present invention relates to the design and fabrication of a push-button shaft coupler for connecting shaft segments to each other. More specifically, it relates to a push-button shaft coupler including a female half coupler and a male half coupler that releasably engage with each other via a button connector. A button travel limiter is further integrated to stop button jams.

### BACKGROUND OF THE INVENTION

Couplers are devices that may be used for connecting shaft segments that rotate a brush or other device when the interior of a fireplace's chimney or a duct is cleaned.

Newth U.S. Pat. No. 10,288,123 describes good-performing two-button and single-button couplers for joining two rotatable shaft segments.

An exemplary coupler of the above '123 patent comprises two mating coupler halves that are secured to each other by a radially-moving pushbutton. A portion of the male coupler half which has a spring loaded button is received within a concavity of the female coupler half. When the coupler halves are mated, the button projects through a radial opening in the wall of the concavity of the female coupler half, thereby securing the two mating coupler halves and enabling transmission of lengthwise and torsional forces between the mated coupler halves. To disengage the coupler halves from each other, a user manually depresses the button. One deficiency of the coupler has been that the spring loaded button has been subject to button jams leading to failure of the coupler. Drilled spring seats have been used in some prior art as a way to reduce button jams, but these spring seats add cost to manufacturing the coupler and do not totally prevent button jams.

Heretofore, exemplary coupler halves have been fabricated from metal bar stock, such as steel or aluminum alloy barstock. To form the interior of the body of a male coupler half, fabrication involves metal removal by lathe-turning, drilling, and milling. These again add cost to the manufacturing.

To reduce manufacturing cost, it would be desirable to use injection molding to make coupler halves of plastic material, such as glass fiber filled Nylon 66. However, if the interior configuration of a machined male coupler body of the Newth '123 patent were to be replicated in an injection molded part, the mold would require complicated and movable mold parts and secondary operations, which lessen the economic benefit that is sought. Thus there is a need for changes in design of coupler parts, particularly the male half coupler so a coupler can be made for low cost while maintaining functionality compared to a metal coupler. There is also a continuing further need to make the coupler more reliable and easier to assemble the male coupler halves which have small interiors, within which it is difficult to insert a pushbutton and associated spring and not have it jam.

### SUMMARY OF THE INVENTION

An object of the invention is to provide an improved configuration of pushbutton coupler, in particular an improved male half coupler that is adapted to economical manufacture, and improved push button reliability.

An embodiment of coupler of the present invention comprises a female half coupler having a concavity which receives and engages a portion of a male half coupler that has a spring actuated push button. The body of the male half coupler has a central lengthwise axis and a blind bore running lengthwise from an opening at the proximal end to a wall at the distal end. The bore has an outer section running from the proximal end to an inner section which runs to the wall. The outer bore section is shaped for attachment to a round cross section shaft. The push button, spring and button travel limiter are positioned within the inner bore section. The push button sets within a radial opening that connects the inner bore section to the exterior of the male coupler half. The push button is urged radially outwardly through the opening by the spring that extends from a recess in the button to the button travel limiter that interfaces with the floor of the inner bore section. Preferably, the inner bore section has a substantially flat floor and a roof which may be curved or flat. In one embodiment, the flat floor starts at the proximal end opening of the bore and runs the whole length of the bore. In another embodiment the flat floor is only present within the inner bore section. In another embodiment the flat floor has a slope of 1 to 4 degrees to the lengthwise axis.

A method of assembly of a male coupler half comprises first inserting the button into the bore from the proximal end of the body to the distal end of the body and into the button opening. A shim is inserted into the bore to create a level surface for moving the spring down the bore and over the button flanges. The spring is compressed, inserted into the bore, and a rod is used to slide the compressed spring from the proximal end of the body to the distal end of the body along the flat floor and flat shim. The spring is aligned to the button recess and allowed to expand.

In embodiments of the invention, the male half coupler comprises a buttress on or close to the end wall. The buttress limits the lengthwise movement of the lower end of the spring during male coupler half assembly, to help locate the spring with respect to the recess of the button. A buttress may comprise one or two pedestals on the floor or a member projecting from the wall.

In embodiments of the invention, the male coupler comprises a button travel limiter. Button travel limiter may be a spring block or buttress. The button travel limiter physically stops the button from moving below the inner bore wall of the male coupler when a user presses the button and thereby stop button jams.

This improved configuration of the interior of the male half coupler makes economical manufacture by injection molding feasible, and makes easier the process of assembly, while still maintaining the functionality associated with prior art machined metal half couplers, and couplers as a whole.

### BRIEF DESCRIPTION OF DRAWINGS

For the purposes of illustrating the invention, the drawings show aspects of one or more embodiments of the invention. However, it should be understood that the present invention is not limited to the precise arrangements and instrumentalities shown in the drawings, wherein:

FIG. 1 is a partial cutaway perspective view of a prior art coupler half body;

FIG. 2 is a transverse cross section of the body of FIG. 1;

FIG. 3 is a perspective view of a button that may be positioned within the body of FIG. 1;

FIG. 4 is a lengthwise cross section of a male coupler half comprising the body of FIG. 1;

FIG. 5a is a perspective view showing a male coupler half and a female coupler half of the present invention as they are situated for mating to form a coupler of the present invention;

FIG. 5b is a rotated perspective view of FIG. 5a;

FIG. 5c is a perspective view of FIG. 5b with the male coupler half inserted into the female coupler half forming a connected coupler;

FIG. 6 is a partial cutaway perspective view of the male coupler half of FIG. 5a;

FIG. 7 is a transverse cross section of the body of FIG. 6 along line 7-7;

FIG. 8 is a lengthwise cross section of the body of FIG. 6 along line 8-8 showing a phantom button, spring and spring block in place;

FIG. 9 is one embodiment of a button travel limiter of the present invention, a spring block, that may be inserted into the male coupler half of FIG. 5a;

FIG. 10 is a lengthwise vertical cross section of the male coupler half of FIG. 8, now having a floor with buttresses adjacent the end wall, the buttresses acting as a button travel limiter;

FIG. 11 is a lengthwise horizontal cross section of the body in FIG. 10 along line 11-11, showing the two spaced apart buttress adjacent the end wall;

FIG. 12a is an inverted lengthwise cross section of the body of FIG. 10 showing a first assembly step where the push button is inserted into the button opening through bore;

FIG. 12b is a lengthwise cross section of the body of FIG. 12a showing a second assembly step with a shim inserted into the bore to level the floor at or above the button flanges;

FIG. 12c is a lengthwise cross section of the body of FIG. 12b showing a third step with the spring compressed and slid down the bore on the shim by a rod;

FIG. 12d is the lengthwise cross section of the body of FIG. 12c showing a fourth assembly step with the spring located over the spring recess;

FIG. 12e is a lengthwise cross section of the body of FIG. 12d showing a fifth assembly step with the spring located in the button recess, the spring expanded and engaging with the button travel limiter (buttresses), and the rod and shim removed from the bore;

FIG. 13a is an inverted lengthwise cross section of the body of FIG. 8. FIG. showing a first assembly step where the push button is inserted into the button opening through the bore and the spring and spring block outside the bore;

FIG. 13b is a lengthwise cross section as in FIG. 13a, showing a second assembly step with a shim inserted into the bore to level the floor at or above the button flanges;

FIG. 13c is a lengthwise cross section as in FIG. 13b, showing a third assembly step with the spring and spring block compress and slid into the bore on the shim by a rod;

FIG. 13d is a lengthwise cross section as in FIG. 13c, showing a fourth assembly step with the spring located over the spring recess and the spring block contacting the distal wall of the bore;

FIG. 13e is a lengthwise cross section as in FIG. 13d, showing a fifth assembly step with the spring located in the button located in the button hole, the spring expanded, the spring block securing the second end of the spring and the shaft and shim removed from the bore;

FIG. 14a is a lengthwise cross section of a coupler comprising a male half coupler and a female half coupler that are engaged with each other when the button is not pressed by the user; and

FIG. 14b is a lengthwise cross section of the coupler of FIG. 14a with the user pressing the button and showing how the spring block acts as a button travel limiter.

### DETAILED DESCRIPTION OF THE INVENTION

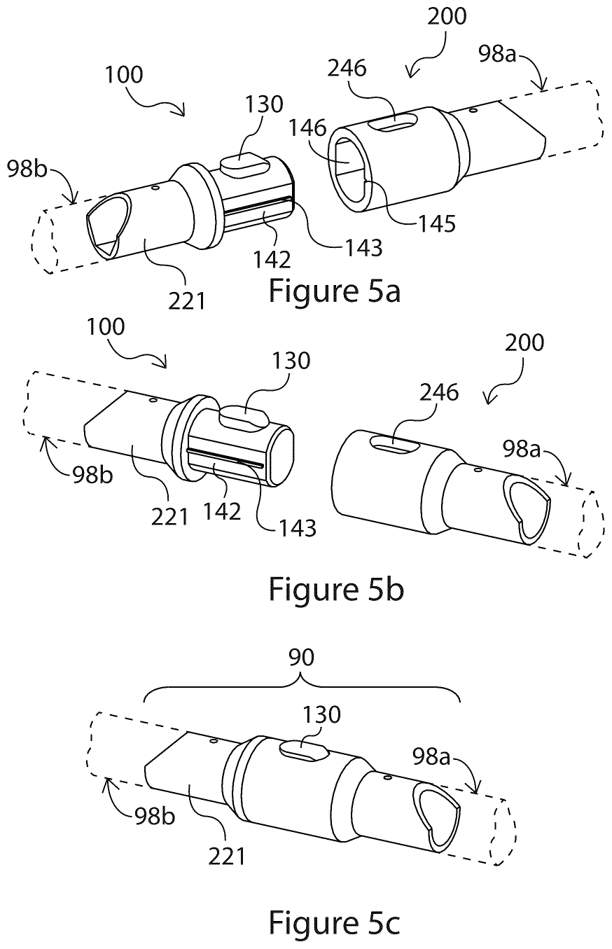

The present invention, FIGS. 5a-14b, includes a coupler 90 which is comprised of a first half coupler and a second half coupler 200 that during use are held together by a spring-actuated push button. (Reference herein and in the claims to a “button” is a reference to a push button.) The second half coupler has a concavity within which is releasably received a portion of the first half coupler that contains the spring loaded button. The first half coupler is often referred to as the male half coupler 100 and the second half coupler is often referred to as the female half coupler 200.

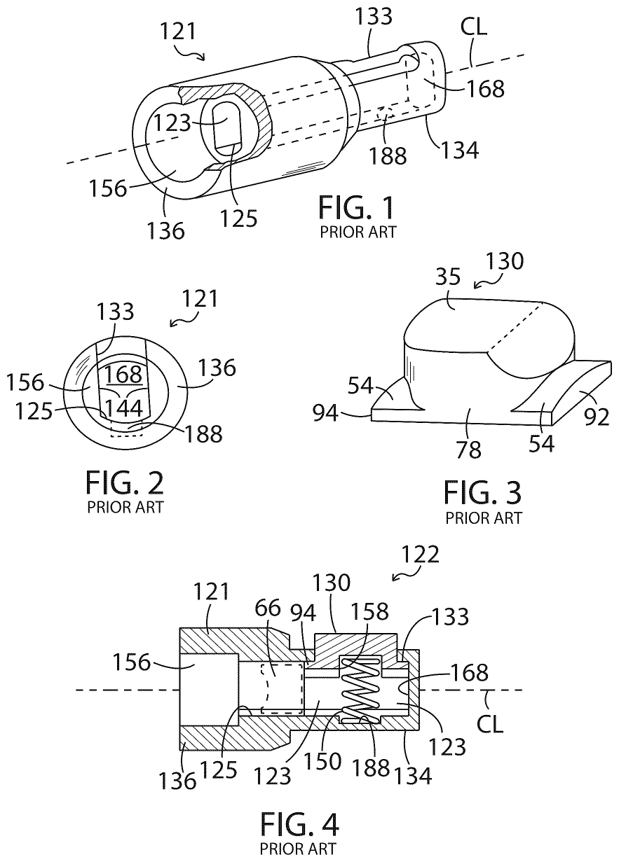

FIGS. 1-4 of the prior art are being included here to define the deficiencies of the prior art and provide context for the present invention. The disclosure of U.S. Pat. No. 10,288,123 is hereby incorporated by reference. FIG. 1 through FIG. 3 of the '123 patent show components of a prior art male coupler half. FIG. 4 shows in cross section the assembled coupler half 122 (also called first fitting 122). FIG. 4 shows how the innermost end of spring 150 sets in a recess 188 in the floor of the coupler half and the outermost end of the spring sets within a recess 158 on the underside of button 130 and a plug 66 to define the push button cavity.

FIG. 1 is a perspective partial cutaway view of the machined body 121 of a prior art male coupler half that is ready for receiving a button and a spring.

FIG. 2 is an end view of body 121. Body 121 has a bore comprised of a circular outer bore portion 156 and an oblong cross section inner bore portion 123. Body 121 has a proximal end 136 and a distal end 134. Bore section 156 runs from the proximal end 136 of the body. Bore section 156 is shaped to fit the end of a circular shaft to which the body is attached during use of a half coupler. The inner bore section 123 runs from bore section 156 to the wall 168 at the distal end of the body.

FIG. 3 shows exemplary button 130 that has a flat top 35 with a bevel. The opposing end flanges 92, 94 of button 130 have curved upper surfaces 54 that mate with the curved contours of bore section 156 of body 121 that are adjacent button opening 133. When button 130 moves during use, the opposing planar sides 78 (only one is visible) fit the opposing planar sides 144 of section 123 of the body, to guide the radial movement of the button. Button 130 and variations may be used within bodies of the present invention that are part of a male half coupler. Useful buttons may have alternative surface finishes on the top 35 which the user typically contacts with a finger to disengage a coupler. For instance, the surface may be flat with no bevel, may be curved, and may have ribbing or other texturing.

In the prior art, body 121 is typically machined from a piece of metal barstock by plunging a drill along lengthwise axis CL, followed by use of one or more end mills to create opposing side walls 144 that are parallel to each other. The button opening 133 is formed by another end-milling operation. A small end mill is then plunged through opening 133 to form recess 188 which enables the innermost end of spring 150 to sit stably on the otherwise curved surface of the floor of the inner bore section.

Referring to body 121 as it is oriented in FIGS. 1, 2, and 4, the machining method that is used leads to a curved “roof’ and a curved “floor” 125 of the inner bore section 123. Because of the length of the bore comprising sections 156, 123, it is practically disadvantageous to produce by ordinary machining a bore with other than curved roof and floor when planar sides 144 for button guidance during use are required.

If the internal configuration of body 121 were replicated by injection molding of a plastic resin, it is likely that cavities 156, 123 would be defined by the core part of the mold, and a slide in the cavity part of the mold would be used to form the button opening 133. A secondary machining operation would likely be needed to form spring recess 188. All of these moveable mold parts and secondary machining operations increase the cost of manufacturing the coupler.

The present invention provides for an improved design of a molded coupler body that avoids the foregoing complications and costs and that also is more reliable in mitigating button jams. FIGS. 5a-c show a single-button male half coupler 100 and a female half coupler 200 of the present invention and how they are used to connect shaft segment 98a to shaft segment 98b. As described in the '123 patent, there are opposing planar surfaces 142 on the exterior of the body 221 of male half coupler 100 which mate with planar surfaces 146 within the bore of the female half coupler 200, to lessen the torque load on button 130 during use of a coupler. FIGS. 5a and b also show a rib 143 that runs lengthwise along only one of the planar surfaces 142 of male half coupler 100, along with a lengthwise groove 145 shaped to receive rib 143 within the bore of female half coupler 200, when the parts are mated. Those are features not taught by the '123 patent. Rib 143 and groove 145 are rotationally polarizing features that permit engagement of the half couplers 100, 200 only when button 130 is aligned with opening 246, thus avoiding avoid engagement of the halves when the button is 180-degrees out of position. Other male-female features that reduce torque load on a button and that polarize the coupler halves may be used in the present invention. Embodiments of the present invention shown in the other figures herein may include the foregoing exterior planar surface features and polarizing features. But, to avoid drawing clutter, those features are not pictured in all other figures.

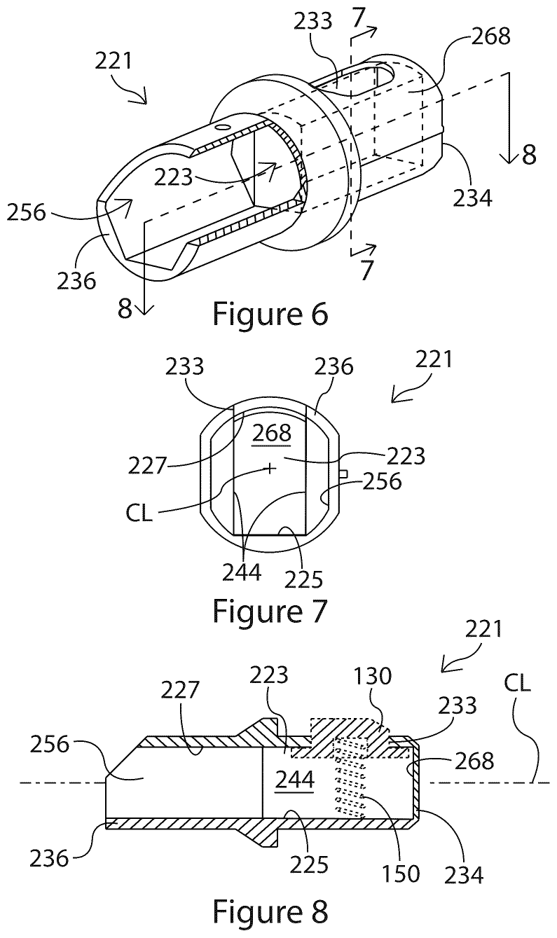

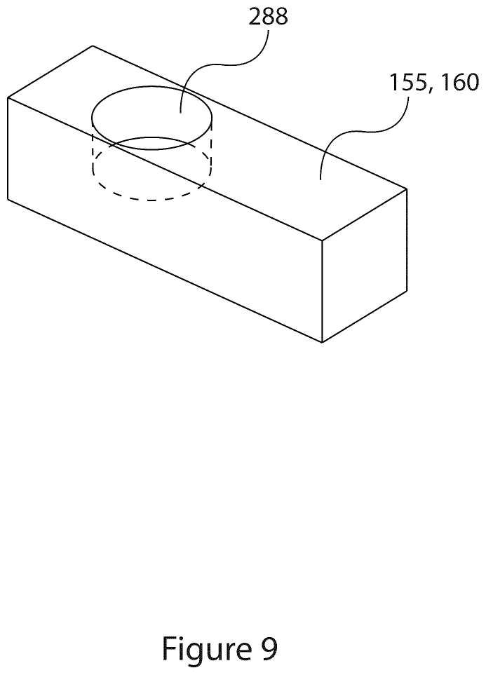

FIGS. 6, 7, 8 and 9 show an exemplary coupler body 221 of the present invention. FIG. 6 is a perspective partial cutaway view, similar to that of FIG. 1. FIG. 7 is a cross section view perpendicular to the centerline of body 221. FIG. 8 is a lengthwise cross section of body 221. FIG. 9 shows one embodiment of button travel limiter 155 that is spring block 150.

The blind bore of body 221 comprises outer section 256 (outer bore) and inner section 223 (inner bore). Outer section 256 extends from body end 236 (the proximal end of the body) to a point where it meets inner bore section 223. Inner bore section 223 extends to integral wall 268 that is at the distal end 234 of the body. During use, the outer bore section 256 is secured to the end of a shaft segment and the inner bore section 223 holds button 130, spring 150 and button travel limiter 155 (either buttresses 380 or spring block 160). Button, spring and button travel limiter, make up button travel limiter assembly 170, FIGS. 9-11. Button opening 233 extends radially form the inner bore section 223 to the exterior of body 221. Flat floor 225 extends lengthwise within the bore of the body, from the proximal end 236 to the wall 268.

For perspective, an exemplary body 221 may have a diameter of about 0.67 inch (17 mm) and the outer section bore might have a diameter of about 0.44 inch (11.2 mm). The floor may be about 0.25 inch (6.4 mm) wide.

In a plane which is perpendicular to the lengthwise axis CL, floor 225 has negligible width-wise curvature, as illustrated in FIG. 7. In a lengthwise direction, floor 225 is substantially flat. See FIG. 8. Floor 225 may rise so it becomes closer to the lengthwise axis CL with distance from end 236. For example, flat floor 225 may have an angle of about 1 to about 4 degrees as a draft for mold release. Such angle range could be reflective of angles associated with plastic molding cores and dies. To provide for securely holding shaft segments 98a and 98b, a zero draft mold design may be used where the inside of the bore angles arrange from 1-4 degrees, but there are ridges in the walls with 0-degrees that will hold the shaft segments 98a and 98b. Floor 225 facilitates sliding placement and functioning of button travel limiter assembly 170, as described below. Floor 225 provides good support for the bottom of the spring block 160. Opposing side walls 244 of the inner bore section 223 are planar and parallel, thus providing opposing sliding surfaces that guide button movement through opening 233

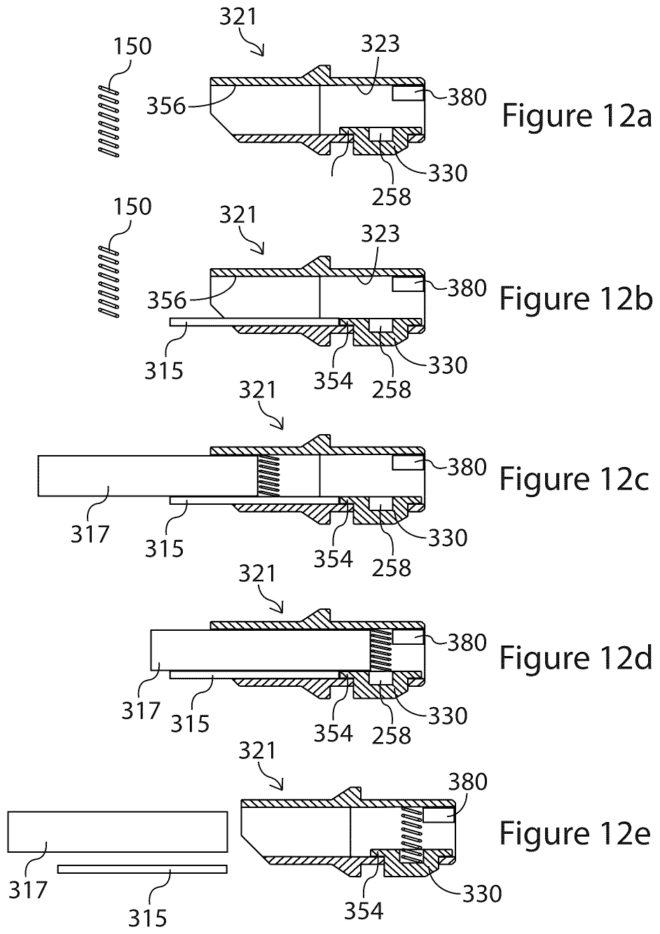

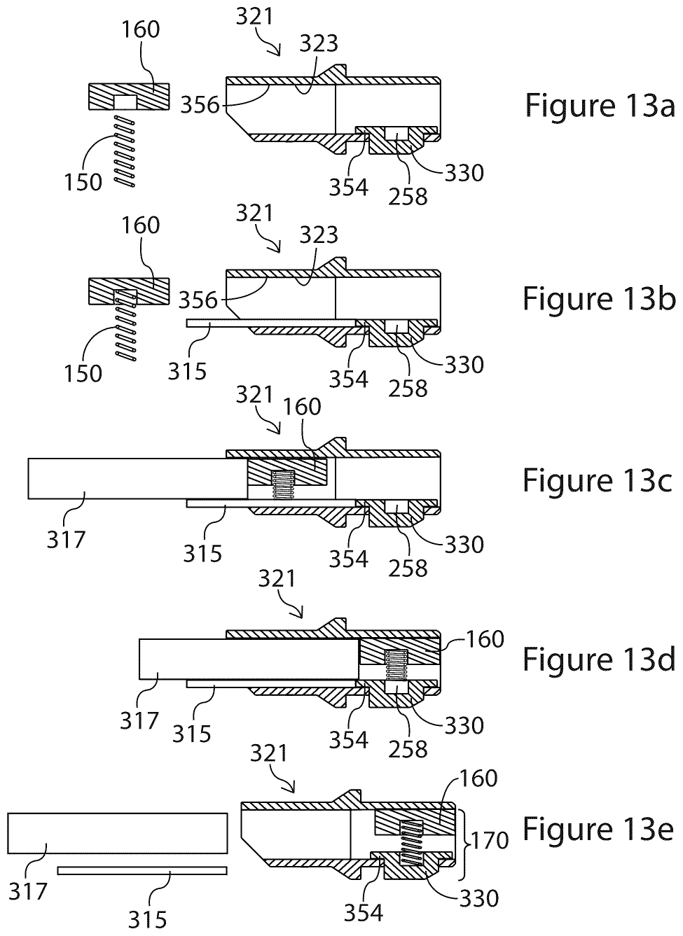

Compared to a curved floor, the flat floor of the present invention enables good, stable sliding of spring 150 or spring block 160 lengthwise during assembly and provides a surface for the base of the spring block that is desirably nearly perpendicular to the spring length and the button travel direction through opening 233. This will be appreciated from discussion below relating to FIGS. 12a-e and FIGS. 13a-e that show various embodiments for assembly. In body 221, floor 225 runs from the proximal end 236 of the body to vicinity of wall 268, as shown in FIG. 6 and FIG. 8. The floor interrupts the circularity of outer bore section 256. In the FIG. 6 embodiment, the flat floor 225 takes up some small percentage of circumference, but most of that circular circumference is still present and that is more than adequate to run around the exterior of a round shaft and hold it. Thus, outer bore section 256 is characterized here as being “substantially circular” in terms of its function of receiving and being secured to a round shaft end. A shaft may be secured to the body by means of such as adhesive, a pin, screw or crimping, none shown. In an alternative embodiment of the invention, it may be sufficient to have a flat floor in the inner bore section 223 and not in the outer bore section 256.

FIG. 8 shows button 130 and spring 150 in phantom working position within body 221. The spring and button used with body 221 are preferably like those described in connection with the prior art coupler half shown in FIG. 1 to FIG. 4. Button travel limiter 155 as a spring block 160 is shown in FIG. 9. The roof 227 of bore section 223 of exemplary body 221 is curved. Thus, the roof portions on either lengthwise side of button hole 233 mate well with the curved upper surfaces of the button flanges 54 of button 130. See FIG. 3.

FIG. 9 shows spring block 160 having a flat surface to engage flat floor 225 and a spring recess 288 to receive spring 150. Spring block 160 is one type of button travel limiter 155 that may be used. Button travel limiter 155 is designed so that the thickness of the block is such as to limit the amount of travel button 130 can move before the base of the button stops at the button travel limiter. The thickness of and location of top of button travel limiter 155 is such that when the button is fully depressed, the top of button 130 will not be allowed to move below the inner bore surface. This combination of support at the second end of spring 150 (recess 288) and stopping the button from moving too far into button opening 333 and into inner bore 323 eliminates button jams.

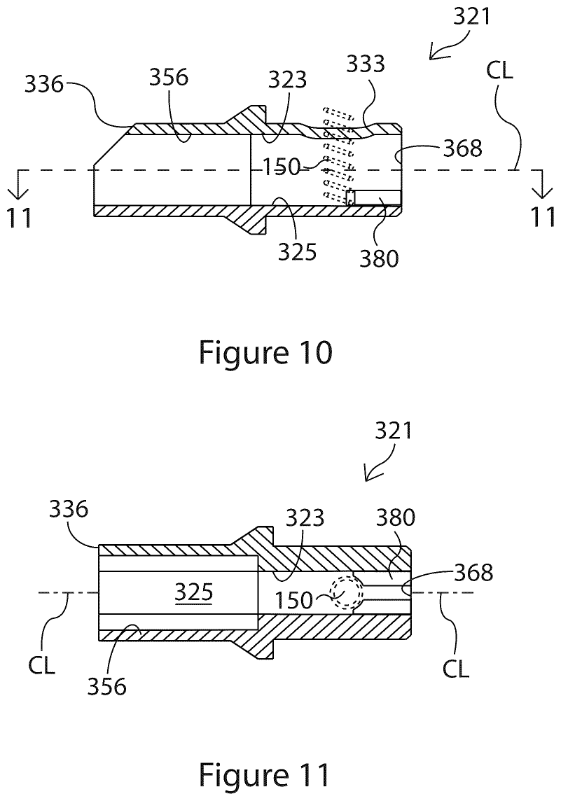

FIGS. 10 and 11 illustrate another embodiment for button travel limiter 155 as buttresses 380. FIG. 10, a vertical lengthwise cross section, and FIG. 11, a horizontal lengthwise cross section that show coupler body 321 which is also largely like body 221. Body 321 has an outer bore section 356, an inner bore section 323, and a flat floor 325. Within the inner bore section 323, there may be two spaced apart buttresses 380 at the distal end of flat floor 325, adjacent end wall 368. The buttresses extend lengthwise from end wall 368 in the direction of proximal end 336. Phantom spring 150 is shown in both FIG. 10 and FIG. 11. (A button within opening 333, at the outer end of the spring may be inferred from the prior figures.) When spring 150 is pushed lengthwise along the bore into place below the button opening during assembly as described below, the lengthwise movement of the spring bottom along floor 325 is stopped when the lower end of the spring contacts the buttresses 380 to help locate the spring and stop unwanted lateral movement of the spring during use. Preferably the buttresses are configured so that the spring will then be centered on button opening 333. The buttresses extend upwardly from the floor a short distance, for example 2 mm, sufficient to provide a barrier for continued lengthwise motion of a spring and limit travel of button 130. Buttresses 380 act as a spring stabilizer. If the buttress is thick enough, the buttress can also limit the movement of the button into the inner bore 323 and act as a button travel limiter 155. The vertical face(s) of the buttress(es) that the spring contacts when pushed lengthwise into the inner bore section 323 may be curved in the horizontal plane to nominally fit the spring outside diameter. In an alternative buttress embodiment, the lateral space between the two buttresses 380 may be filled in, to provide a single buttress that extends across the width of the inner bore section at the bottom of wall 368. A preferred way of assembling a small male half coupler which comprises a body of the present invention is as follows: An exemplary coupler for use with a shaft/rod segments that are about 5/16 inch (8 mm) diameter may have an about 7/16 inch (11 mm) outside diameter. It should be appreciated that the small size of the coupler makes assembly trickier than may appear from the drawings here.

Assembly of male half coupler 100 with two buttresses is a follows. With reference to FIGS. 12a-e and exemplary body 321, an assembler (which may be a worker or automated piece of equipment) first slides the button 330 lengthwise and into the opening 333 with the opening facing downward so the button in held in place by gravity, FIG. 12a. A shim 315 is inserted into the bore 356 to create a surface level or slightly hire with button flange 354 for sliding spring 150, FIG. 12b. Spring 150 is then compressed as shown in the FIG. 13c and slid in that condition lengthwise within outer bore section 356 and inner bore section 323 via rod 317. Spring 150 slides along flat floor 225. A compression fixture, not shown, may be used for the spring. The spring is moved to a point in the bore which is beneath the recess 258 of button 330, when the bottom end of the spring hits buttress 380. Then spring compression is released, allowing one spring end to set within recess 258 of the button and allowing the other spring end to rest of flat floor 325, FIG. 12e.

Another way to assemble a male half coupler having a body along the lines of body 321 would be to set a first end of the spring within the button recess, and then slide the spring and button assembly lengthwise along the bore while keeping the spring compressed due to contact of the spring second spring end with the floor of the bore, or with a fixture. With sufficient lengthwise movement the button will “pop into” the button opening 333, perhaps sometimes with jiggling-help of an assembler.

Assembly of male half coupler 100 with the button limiter assembly 170 having a spring block 160 is as follows. With reference to FIGS. 13a-e and exemplary body 321, an assembler first slides the button 330 lengthwise and into the opening 333 with the opening facing downward so the button in held in place by gravity, FIG. 13a. A shim 315 is inserted into the bore to create a surface level with spring flange 354 for sliding spring 150, FIG. 13b. Spring 150 and spring block 160 are then compressed as shown in the FIG. 13c and slid in that condition lengthwise within outer bore section 356 and inner bore section 323 via rod 317. Compressed spring 150 and spring block 160 slides along flat floor 325 and flat shim 315. A compression fixture, not shown, may be used for the spring and spring block. The spring is moved to a point in the bore which is beneath the recess 258 of button 330, when the bottom end of the spring hits buttress 380, FIG. 13d. Then spring compression is released, allowing one spring end to set within recess 258 of the button and allowing the other spring end to rest within recess 288 of spring block 160, FIG. 13e.

Coupler halves of the present invention may be made of injection molded Nylon 66 that is 30 percent glass fiber filler. Other plastic materials may be used. The button may be made of plastic or metal. The spring is preferably a steel coil spring. Other kinds of springs may be used. An exemplary spring used with the 7/16 in (11 mm) outside diameter coupler mentioned above is made of 0.030 inch (0.76 mm) diameter wire, has an about 0.234 inch (6 mm) diameter, a free length of about 0.49 inch (12 mm). Spring block 160 may be made of plastic or metal. A button used with the spring may have a pocket 258/button recess that has a depth of about 0.08 inch (2 mm). When the button is depressed sufficient to enable disengagement of a coupler, the exemplary spring will be compressed about 25-30 percent compared to the spring length when the button is at its home (maximally outward) position. A buttress 380 of the 7/16 inch (11 mm) half coupler may be about 0.095 inch to 0.115 inch (2.4 mm to 2.9 mm) high relative to floor 325.

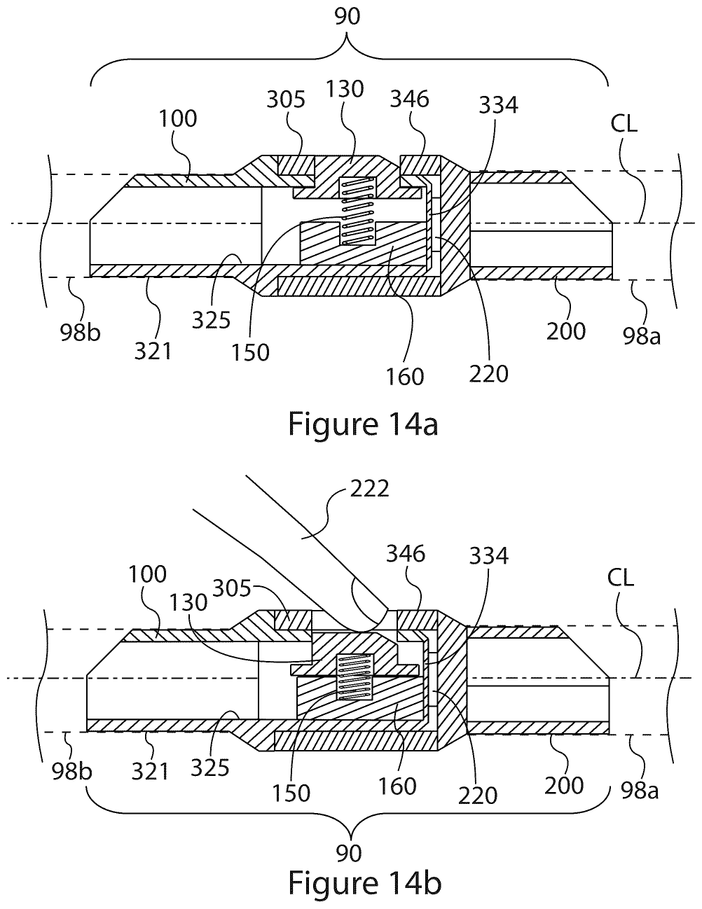

FIG. 14a shows in lengthwise cross section coupler 90 comprising male half coupler 100 that is mated with female half coupler 200, to connect shaft segments 98a, 98b, shown in phantom. Each shaft segment may be secured within the proximal end-cavity of a coupler half by adhesive, crimping, screwing or pinning (not shown). Spring 150 sets within the recess of button 330 and within spring block 160 that rests on the flat floor 325. When the two coupler halves were being mated, the distal end 334 of coupler half 100 entered the bore 220 of half coupler 200. During that process, the distal end 305 of coupler half 200 hit buttons 330 causing the button to move inwardly against the spring. With further mating motion, the spring caused button 330 to move outwardly into the radial opening 346 of coupler half 200, thereby holding the two coupler halves to each other, as pictured.

FIG. 14b shows in lengthwise cross section coupler 90 of FIG. 14a, now with a user's finger 222 pressing button 330 as far as it will travel against the force of spring 150. The base of button 130 hits the top of spring block 160. It can be observed that the top of the button will not move into inner bore 323 and therefore stops button jams.

The objects of the invention are achieved. The invention accommodates injection molding without expensive multi-piece molds. The need for machining a recess for the spring within the inner bore is eliminated. There is improved ease of positioning of the spring and button. There is the elimination of button jams due to the button travel limiter.

While several embodiments of the invention, together with modifications thereof, have been described in detail herein and illustrated in the accompanying drawings, it will be evident that various further modifications are possible without departing from the scope of the invention. The scope of the claims should not be limited by the preferred embodiments set forth in the examples, but should be given the broadest interpretation consistent with the description as a whole.

What is claimed is:

1. A coupler for connecting two shaft segments comprising: a female half coupler and a male half coupler that releasably engage with each other,
wherein the female half coupler comprises
a female body having a proximal end and a distal end spaced apart along a lengthwise axis,
the proximal end configured to receive an end of one of the shaft segments, and
the distal end comprising a circumscribing wall, the wall having a radially extending female half coupler button opening, the wall defining a cavity configured to releasably receive the distal end of the male half coupler;
wherein the male half coupler comprises
a body having a proximal end and a distal end spaced apart along a lengthwise axis,
a bore, running lengthwise within the body from the proximal end to a wall at the body distal end, the bore having
an outer bore portion that is substantially circularly shaped, for receiving an end of one of said shaft segments, and
an inner bore portion running from the outer bore portion to said distal end wall;
a male half coupler button opening extending radially from the inner bore section to the exterior of the body;
a button positioned within the male half coupler button opening, the button having a recess facing the lengthwise axis;
a substantially flat floor running within the bore from said body proximal end to proximity of the distal end wall;
a button travel limiter;
a spring having a first end set within the recess of the button and a second end set to engage the button travel limiter;
wherein when the distal end of the male half coupler is positioned within the cavity of the female half coupler, the button is spring urged radially outward within the button opening of the male half coupler and within the button opening of the female half coupler, thereby holding the half couplers in engagement.

2. The coupler of claim 1, wherein the button travel limiter is a spring block having a spring block recess.

3. The coupler of claim 1, wherein the button travel limiter has a thickness and top, wherein the top of the button travel limiter stops the button from fully traveling into the inner bore.

4. The coupler of claim 1, wherein the button travel limiter is a buttress adjacent to said distal end wall, the buttress extending lengthwise from said distal end wall to vicinity of said spring second end.

5. The coupler of claim 1, wherein the male half coupler further comprises a curved roof within the inner bore portion, and planar parallel walls extending from said flat floor in the direction of the male half coupler button opening.

6. The coupler of claim 1, wherein the cavity of the female half coupler has opposing planar walls, and a lengthwise groove running along one of said planar walls; wherein the exterior of the distal end of the male half coupler body has opposing planar walls and a lengthwise rib running along one of said planar walls; and, wherein when the distal end of the male half coupler is positioned within said cavity of the female half coupler, the planar walls of the male half coupler and the planar walls of the female half coupler abut, and said lengthwise rib is positioned within said lengthwise groove.

7. A male half coupler for use with a releasably engaged female half coupler to connect two rotatable shaft segments, comprising:
a body having a proximal end and a distal end spaced apart along a lengthwise axis, a bore, running lengthwise within the body from the proximal end to a wall at the body distal end, the bore having
an outer bore portion that is substantially circularly shaped, for receiving an end of one of said shaft segments, and
an inner bore portion running from the outer bore portion to said distal end wall;
a male half button coupler opening extending radially from the inner bore section to the exterior of the body;
a button positioned within the male half coupler button opening, the button having a recess facing the lengthwise axis;
a substantially flat floor running within the bore from said body proximal end to proximity of said distal end wall;
a button travel limiter;
a spring having a first end set within the recess of the button and a second end set to engage the button travel limiter;
wherein, when the distal end of the male half coupler is positioned within the cavity of the female half coupler, the button is spring urged radially outward within the button opening of
the male half coupler and within the button opening of the female half coupler, thereby holding the half couplers in engagement.

8. The male half coupler of claim 7, wherein the button travel limiter is a spring block having a spring block recess.

9. The coupler of claim 7, wherein the button travel limiter has a thickness and top, wherein the top of the button travel limiter stops the button from fully traveling into the inner bore.

10. The male half coupler of claim 7, wherein the button travel limiter is a buttress adjacent to said distal end wall, the buttress extending lengthwise from said distal end wall to vicinity of said spring second end.

11. The coupler of claim 7, wherein the male half coupler further comprises a curved roof within the inner bore portion, and planar parallel walls extending from said flat floor in the direction of the male half coupler button opening.

12. The male half coupler of claim 7, wherein the flat floor is inclined at an angle of about 1 to 4 degrees to the lengthwise axis.

13. The male half coupler of claim 7, wherein the exterior of the distal end has opposing planar walls and a lengthwise rib running along one of said planar walls.

14. A method of fabricating a male half coupler which comprises:
providing
(a) a body having a proximal end and a distal end spaced apart along a lengthwise axis, the body having a bore running lengthwise within the body from the proximal end to a wall at the body distal end, the bore having an outer bore portion that is substantially circularly shaped, for receiving an end of one of said shaft segments, and an inner bore portion running from the outer bore portion to said distal end wall, a button opening extending radially from the inner bore section to the exterior of the body; and, a flat floor running within the bore from said body proximal end to proximity of said distal end wall;
(b) a button shaped to fit within the male half coupler button opening, the button having opposing flanges with a recess therebetween;
(c) a button travel limiter; and,
(d) a spring having a first end shaped to fit within said button recess and a second end shaped to engage with the button travel limiter; and,
compressing the spring and sliding the spring from the proximal end of the bore to the distal end of the bore with the spring second end in contact with the flat floor, and positioning the spring first end into the button recess and the second end to engage the travel limiter, and allowing the spring to expand; or
inserting the second end of the spring into a recess of the button travel limiter, then compressing the spring and button travel limiter, placing the compressed spring with button travel limiter into the bore and sliding the compressed spring and button travel limiter from the proximal end of the body to the distal end of the body, and positioning the spring first end into the button recess and allowing the spring to expand.

15. The method of claim 14, further comprising a shim for inserting into the bore against the flat floor after the button has been inserted.

16. The method of claim 14, further comprising a rod for inserting into the bore to move the spring and button travel limiter within the bore.

17. The method of claim 14, wherein exterior planer surfaces of the male coupler and interior planer surfaces of the female coupler that include mating interference shapes that orient the male and female in assembly.
